(19) United States
(12) Patent Application Publication
(10) Pub. No.: US 2004/0222572 A1
(43) Pub. Date: Nov. 11, 2004

(54) Sialon ceramics

(76) Inventor: Geoffrey Vaughan White, Lower Hutt (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/477,618

(22) PCT Filed: May 15, 2002
(86) PCT No.: PCT/NZ02/00096

(30) Foreign Application Priority Data
May 16, 2001 (NZ) 511737

(51) Int. Cl. C04B 33/32

(52) U.S. Cl. 264/647; 264/604; 264/638; 264/637

(57) ABSTRACT

The invention provides a process for the production of sialon ceramic (and a sialon ceramic produced by such a process) comprising or including the steps of: (I) preparing a sialon reactant mixture including or comprising: a) silicon metal; b) clay; and c) a secondary aluminium source; (II) heating the reactant mixture in an atmosphere containing nitrogen gas to a temperature sufficient to substantially react the silicon metal, the secondary aluminium source and the nitrogen with the clay to form or to contribute to the forming of the sialon product; wherein the clay participates in the reaction as a source of aluminium and silicon. Further, the invention provides a method for preparing a sialon ceramic in a predetermined shape.

### TECHNICAL FIELD

The invention relates to a process for the production of silicon aluminium oxynitride (sialon) ceramics and in particular to the production of alpha-sialon, beta-sialon, and composites of these. Other sialon phases such as X-phase, O-phase and aluminium nitride polytypes can also be made by this process.

### BACKGROUND

The term sialon, or silicon aluminium oxynitride, encompasses a family of compounds or phases comprised of the elements: silicon, aluminium, oxygen and nitrogen. Each phase is described by a composition range for which that particular structure is stable.

O-sialon is stable over the composition range: Si_{2-X}Al_{X}O_{1+X}N_{2-X} where x=0 to 0.4. This includes silicon oxynitride (Si₂ON₂) as the x=0 end member. O-sialon has the same structure as silicon oxynitride (Si₂ON₂), and can be regarded as a solid solution formed by substituting equal amounts of aluminium and oxygen for silicon and nitrogen respectively into the silicon oxynitride structure. The amounts of aluminium and oxygen that can be substituted into this structure increase with temperature. At 1600° C., x can range from zero to 0.2 At 1900° C., x can be as high as 0.4.

Beta-phase sialon (beta-sialon) is stable over the composition range: Si_{6-z}Al_{z}O_{z}N_{8-z} where z=0 to 4.2. This includes silicon nitride (beta-Si₃N₄) as the z=0 end member. beta-sialon has the same crystallographic structure as beta silicon nitride (beta-Si₃N₄), and can be regarded as a solid solution formed by substituting equal amounts of aluminium and oxygen for silicon and nitrogen respectively into the silicon nitride structure.

The amounts of aluminium and oxygen which can be substituted into this structure increase with temperature. At 1750° C., z can range from 0 to 4.2. In general terms beta-sialon compositions can be thought of as low z compositions and high z compositions with low z being <3 and high z being >3. The z value refers to the aluminium content of the composition.

Alpha-phase sialon (alpha-sialon) has a structure derived from alpha-Si₃N₄ and is stabilised by a metal cation (M) such as Y, Li, Ca. The general formula is where m and n indicate the replacement of (m+n) (Si—N) bonds by m(Al—N) and n(Al—O) bonds and v represents the valency of the metal cation M.

X-sialon has a structure similar to mullite. It occurs over a very limited composition range as a solid solution between mullite and silicon nitride.

Aluminium nitride polytypes have small ranges of stable composition close to aluminium nitride with structures based on the aluminium nitride or wurtzite structure.

Sialons are advanced ceramic materials which exhibit useful properties such as high strength and hardness, low density, wear resistance and corrosion resistance, and are able to retain these properties at high temperatures. In general alpha-sialon, when fully dense, is a very hard material but brittle; beta-sialon is less hard but tough. A composite of the two is a good compromise and yields excellent mechanical strength and wear resistance. X-sialon is resistant to molten iron and steel suggesting application as a refractory. Aluminium nitride polytypes are used commercially as a precursor in a mixture to form alpha- and beta-sialons.

O-sialon has similar properties to silicon oxynitride, which include excellent resistance to oxidation and thermal shock. Silicon oxynitride is commonly used as a refractory material.

Sialons are used in refractories and for a variety of engineering applications such as cutting tools, spray nozzles and pump seals. The exact properties of a given sialon depend on the chemical composition and fabrication variables, such as purity, grain size and shape, and the method of fabrication. Beta-sialon has similar properties to silicon nitride which include excellent resistance to attack by molten metal. Silicon nitride is commonly used as a high performance refractory material.

Documents indicating the state of the art include:

U.S. Pat. No. 3,960,581 to Ivan B Cutler discloses a process for making sialons from readily available raw materials, such as clay, together with carbon. There is no teaching or recognition however of the use of silicon metal in the process. Use of silicon metal allows synthesis of low z sialon compositions.

DD 263749 to Akad Wissenschaft DDR, inventor Schikore H, which describes the production of sialon-based materials from a charge containing by weight (A) 75-95% clay, 5-25% carbon, and 0-50% aluminium compounds; or (3) 50-80% clay, 20-50% silicon carbide, and 0-50% aluminium compounds. No disclosure of the use of silicon metal is made and carbon or silicon carbide must be used.

U.S. Pat. No. 4,360,506, inventor Paris R A, which discloses the formation of beta-sialons from a paste comprising silico-aluminous material (clay), carbon, and fine particles of a ligneous material (eg sawdust). The carbon and ligneous material are essential and no mention of the silicon metal is made.

U.S. Pat. No. 4,871,698, inventors Fishler et al, use silicon metal in the production of a refractory body. The other constituents include carbon, beta-sialon, clay, silica and silicon carbide amongst others.

The PCT patent application filed in June 1995, inventors G. Barris and G. Hodren, by Industrial Research Limited et al PCT application (WO95/33700-PCT/NZ95/00050) discloses the synthesis of O-sialon from mixtures of clay and silicon, assuming no loss of gaseous species from the system. No mention of the use of aluminium metal or aluminium nitride is made.

The process for the Production of Ceramic Materials, PCT Patent Application No.PCT/NZ96/00122 (WO97/16388) Nov. 1, 1996 by Industrial Research Limited et al discloses the synthesis of alpha-sialon and beta-sialon from mixtures of clay and silicon and carbon, assuming loss of gaseous species from the system. No mention of the use of aluminium metal or aluminium nitride is made.

Other common methods for producing sialons include:

(i) Reaction Sintering of mixtures of two or more of the following: Si₃N₄, SiO₂, Al₂O₃, AlN, and AlN-polytypoids, at >1600° C. under a nitrogen atmosphere, usually in the presence of a rare earth sintering aid such as Y₂O₃ or CeO₂. This process involves expensive raw materials and high temperatures, but allows good control over the composition and purity of the product.

(ii) Carbothermal Reduction. Aluminosilicate minerals are blended with carbon and fired at >1350° C. under a flowing nitrogen atmosphere. This process is described as carbothermal reduction because the carbon acts by reducing the aluminosilicate, allowing nitridation to occur. This process involves cheap raw materials and lower firing temperatures than for reaction sintering. The process is more difficult to control because it involves stopping a reaction at a specific point prior to completion.

(iii) Combustion Synthesis. A mixture containing silicon metal powder is ignited under a nitrogen atmosphere. The energy evolved by the strongly exothermic nitridation of silicon propagates a reaction front through the reaction mixture. This method is very rapid and energy efficient but is difficult to control.

Methods (ii) and (iii) both yield sialon powders which must then be formed and sintered to obtain a ceramic body. Method (i) is the most commonly used method for preparing alpha- and beta-sialon. As is apparent from above known methods, in order to get good control over the composition and purity of the product expensive raw materials and/or extreme reaction conditions are required.

### OBJECT OF THE INVENTION

It is an object of the invention to provide an improved or alternative process for the production of one or more of alpha-, beta-, X-sialons, O-sialons, and aluminium nitride polytype sialons, and mixtures thereof

### STATEMENTS OF THE INVENTION

In the first aspect the invention comprises a process for the production of sialon ceramic including or comprising or including the steps of.

(I) preparing a sialon reactant mixture including or comprising:

a) silicon metal,

b) clay, and

c) a secondary aluminium source;

(II) heating the reactant mixture in an atmosphere containing nitrogen gas to a temperature sufficient to substantially react the silicon metal, the secondary aluminium source and the nitrogen with the clay to form or to contribute to the forming of the sialon product,

wherein the clay participates in the reaction as a source of aluminium and silicon.

Preferably the secondary aluminium source has a sufficiently fine particle size such that substantially all the secondary aluminium source reacts in the process.

Preferably the secondary aluminium source has a sufficiently fine particle size such that substantially all the secondary aluminium source reacts within a time period of substantially 12 hours; more preferably 8 hours.

Preferably the secondary aluminium source is one of more of aluminium metal, aluminium nitride, non-oxide aluminium salts.

Preferably the non-oxide aluminium salts may be aluminium chloride or aluminium fluoride.

Preferably all of the reactant mixture constituents are introduced as fine powders.

In one embodiment of the first aspect of the invention the sialon product is substantially all in the alpha-phase.

In another embodiment of the first aspect of the invention the sialon product contains one or more of the sialon phases (which may include for example, alpha-, beta-O-X-phases, and AlN polytype sialons).

Preferably the process includes addition of one or more alpha-phase stabilising cation sources, in order to promote the formation of the alpha-phase relative to any other sialon product phase.

Preferably the one or more cation sources include non-oxide salts of yttrium, calcium, magnesium, sodium and lithium.

Preferably the one or more cation sources are or include lithium chloride and/or lithium fluoride.

In one form, following addition of the one or more alpha-phase stabilising cation sources, the sialon product is substantially all in the alpha-phase.

Alternatively the sialon product is a mixture of sialon-phases.

Preferably the ratio of sialon phases may be controlled by control of one or more of

i) cation identity,

ii) relative cation amount,

iii) temperature,

iv) duration and/or conditions of the exposure of the mixture to heat and/or nitrogen gas.

Preferably the mixture of phases may include alpha-, beta-, O-, and X-phases or aluminium nitride polytype sialons.

Preferably the mixture is heated to between about 1000° C. and about 1700° C., more preferably between about 1150° C. and about 1550° C., more preferably between about 1200° C. and about 1500° C. and most preferably 1300° C.

Preferably the components are heated at a rate of between substantially about 1° C. and about 20° C. per minute, more preferably between 1° C. and 10° C. per minute, more preferably between about 1° C. and about 5° C. per minute, more preferably between about 1.5° C. and about 2.5° C. per minute and most preferably at about 2° C. per minute.

Preferably the components are held at the required temperature for up to about 12 hours and most preferably for up to about 8 hours.

Preferably the process may include the addition of a source of fluoride or chloride ions to the reactant mixture to promote the formation of the alpha-phase.

Preferably the process may include the addition of a source of fluoride or chloride ions and use of a reduced temperature and/or reaction time, in order to promote the formation of the alpha-phase.

Preferably the source of the fluoride or chloride ions is aluminium fluoride or aluminium chloride which also acts as the secondary aluminium source.

Alternatively the source of the fluoride or chloride ions is calcium-, magnesium-, sodium-, or lithium fluoride which also act(s) as the one or more alpha-phase stabilising cation sources.

Preferably the process includes mixing the reactant mixture with one or more sintering aids.

Preferably the one or more sintering aids are selected from oxides or non-oxide salts of yttrium, calcium, magnesium, cerium, sodium, potassium and/or lithium. Preferably, the one or more sintering aids are selected from the non-oxide salts of yttrium, calcium, magnesium, cerium, sodium, potassium and/or lithium, and may also act as the one or more alpha-phase stabilising cation sources.

Preferably the process includes the addition of one or more ceramic materials which remain substantially unreacted throughout the reaction.

Preferably the one or more ceramic materials have an average coarser particle size than other species present which react in the process.

Preferably the one or more ceramic materials take the form of coarse granules and/or particles and/or fibres.

Preferably the one or more ceramic materials may be one or more of silicon carbide, alumina, silicon nitride, sialon, zirconia, silica or aluminium nitride.

Preferably the one or more ceramic materials will constitute up to about 75% by weight of the mixture, and more preferably between about 40% and about 70% by weight of the mixture.

Preferably the atmosphere is substantially pure nitrogen, a hydrogen/nitrogen mixture or ammonia.

Preferably the atmosphere is a flowing gas atmosphere.

Preferably the atmosphere is purified to substantially remove oxygen-containing impurities.

Preferably the flowing N₂ atmosphere comprises about <0.5% oxygen and about <0.5% water vapour.

In one form of the invention the clay is an hydrated clay mineral. Preferably the clay is a hydrated aluminosilicate and more preferably a kaolin clay. Preferably the clay may contain a free silica component.

Alternatively the clay is dehydroxylated or an aluminosilicate product of dehydroxylation such as mullite, or an aluminosilicate mineral such as molochite, silimanite or kyanite.

Preferably the process of the invention includes a pre-step of dehydroxylating the clay.

Preferably the clay content in the starting mixture is between about 2 and 85% by weight and more preferably between 20 and 30% by weight.

Preferably any O-sialon formed by the process of the invention is within the composition range:

Si_{2-X}Al_{X}O_{1+X}N_{2-X}

where x is in the range of 0 to 0.4

Preferably any beta-phase sialon formed by the process of the invention is within the composition range:

Si_{6-z}Al_{z}O_{z}N_{8-z}

where z is in the range of 0.1-4.2.

Preferably any alpha-phase sialon formed by the process of the invention has a composition characterised by the general formula:

M_{m/v}Si₁₂₋₍ₘ₊ₙ₎Alₘ₊ₙOₙN₁₆₋ₙ

where M is a metal cation having a valence v and where m and n indicate the replacement of (m+n) (Si—N) bonds by m(Al—N) and n(Al—O) bonds in the alpha-Si₃N₄ structure.

Preferably the sialon reactant mixture includes or comprises, by weight, about 2% to about 85% clay, about 5% to about 95% silicon metal and 2% to about 50% secondary aluminium nitride.

More preferably the sialon reactant mixture includes or comprises by weight 50% to 70% silicon metal, 20% to 40% clay, and 5 to 10% secondary aluminium source.

Alternatively the sialon reactant mixture includes or comprises, by weight, about 2% to about 60% clay, about 5% to about 95% silicon metal and 2% to about 50% aluminium nitride, the reactant mixture comprising up to substantially 50% of the starting materials and the one or more ceramic materials comprise up to substantially 75% of the starting materials.

Preferably the product of the process is a sialon powder. Alternatively the product is a sialon ceramic body, preferably of a pre-selected shape. Preferably the shape is pre-selected by the use of a shape selecting technique including pressing, slip casting, extruding, isostatic pressing or injection moulding.

In a second aspect the present invention comprises a sialon ceramic prepared according to the above process.

In a third aspect of the invention there is provided a method of forming a sialon ceramic in a pre-selected shape, comprising or including the steps of

(I) preparing a sialon reactant mixture including or comprising:

a) silicon metal,

b) clay, and

c) a secondary aluminium source;

(II) shaping the sialon reactant mixture in accordance with the pre-selected shape,

(III) heating the reactant mixture in an atmosphere containing nitrogen gas to a temperature sufficient to substantially react the silicon metal, the secondary aluminium source and the nitrogen with the clay to form or to contribute to the forming of the sialon product,

wherein the clay participates in the reaction as a source of aluminium and silicon.

Preferably the shaping step (II) involves shaping the reactant mixture by a technique such as pressing, slip casting, extruding, isostatic pressing, injection moulding.

Preferably the secondary aluminium source has a sufficiently fine particle size such that substantially all the secondary aluminium source reacts in the process.

Preferably the secondary aluminium source has a sufficiently fine particle size such that substantially all the secondary aluminium source reacts within a time period of substantially 12 hours; more preferably 8 hours.

Preferably the secondary aluminium source is one of more of aluminium metal, aluminium nitride, non-oxide aluminium salts.

Preferably the non-oxide aluminium salts may be aluminium chloride or aluminium fluoride.

Preferably all of the reactant mixture constituents are introduced as fine powders.

In one embodiment of the first aspect of the invention the sialon product is substantially all in the alpha-phase.

In another embodiment of the first aspect of the invention the sialon product contains one or more of the sialon phases (which may include for example, alpha-, beta-O-X-phases, and AlN polytype sialons).

Preferably the process includes addition of one or more alpha-phase stabilising cation sources to the reactant mixture, in order to increase the yield of the alpha-phase relative to any other sialon product phase.

Preferably the one or more cation sources include non-oxide salts of yttrium, calcium, magnesium, sodium and lithium.

Preferably the one or more cation sources are or include lithium chloride and/or lithium fluoride.

In one form, following addition of the one or more alpha-phase stabilising cation sources, the sialon product is substantially all in the alpha-phase.

Alternatively the sialon product is a mixture of sialon-phases.

Preferably the ratio of sialon phases may be controlled by control of one or more of:

i) cation identity,

ii) relative cation amount,

iii) temperature,

iv) duration and/or conditions of the exposure of the mixture to heat and/or nitrogen gas.

Preferably the mixture of phases may include alpha-, beta-, O-, and X-phases or aluminium nitride polytype sialons.

Preferably the mixture is heated to between about 1000° C. and about 1700° C., more preferably between about 1150° C. and about 1550° C., more preferably between about 1200° C. and about 1500° C. and most preferably 1300° C.

Preferably the components are heated at a rate of between substantially about 1° C. and about 20° C. per minute, more preferably between 1° C. and 10° C. per minute, more preferably between about 1° C. and about 5° C. per minute, more preferably between about 1.5° C. and about 2.5° C. per minute and most preferably at about 2° C. per minute.

Preferably the components are held at the required temperature for up to about 12 hours and most preferably for up to about 8 hours.

Preferably the process may include the addition of a source of fluoride or chloride ions to the reactant mixture to promote the formation of the alpha-phase.

Preferably the process may include the addition of a source of fluoride or chloride ions and use of a reduced temperature and/or reaction time, in order to promote the formation of the alpha-phase.

Preferably the source of the fluoride or chloride ions is aluminium fluoride or aluminium chloride which also acts as the secondary aluminium source.

Alternatively the source of the fluoride or chloride ions is calcium-, magnesium-, sodium-, or lithium fluoride and also acts as the one or more alpha-phase stabilising cation sources.

Preferably the process includes mixing the reactant mixture with one or more sintering aids.

Preferably the one or more sintering aids are selected from oxides or non-oxide salts of yttrium, calcium, magnesium, cerium, sodium, potassium and/or lithium.

Preferably, the one or more sintering aids are selected from the non-oxide salts of yttrium, calcium, magnesium, cerium, sodium, potassium and/or lithium, and may also act as the one or more alpha-phase stabilising cation sources.

Preferably the process includes the addition of one or more ceramic materials to the reactant mixture which remain substantially unreacted throughout the reaction.

Preferably the one or more ceramic materials have an average coarser particle size than other species present which react in the process.

Preferably the one or more ceramic materials take the form of coarse granules and/or particles and/or fibres.

Preferably the one or more ceramic materials may be one or more of silicon carbide, alumina, silicon nitride, sialon, zirconia, silica or aluminium nitride.

Preferably the one or more ceramic materials will constitute up to about 75% by weight of the mixture, and more preferably between about 40% and about 70% by weight of the mixture.

Preferably the atmosphere is substantially pure nitrogen, a hydrogen/nitrogen mixture or ammonia.

Preferably the atmosphere is a flowing gas atmosphere.

Preferably the atmosphere is purified to substantially remove oxygen-containing impurities.

Preferably the flowing N₂ atmosphere comprises about <0.5% oxygen and about <0.5% water vapour.

In one form of the invention the clay is an hydrated clay mineral. Preferably the clay is a hydrated aluminosilicate and more preferably a kaolin clay. Preferably the clay may contain a free silica component.

Alternatively the clay is dehydroxylated or an aluminosilicate product of dehydroxylation such as mullite, or an aluminosilicate mineral such as molochite, silimanite or kyanite. Preferably the process of the invention includes a pre-step of dehydroxylating the clay.

Preferably the clay content in the starting mixture is between about 2 and 85% by weight and more preferably between 20 and 30% by weight.

Preferably any beta-phase sialon formed by the process of the invention is within the composition range:

Si_{6-z}Al_{z}O_{z}N_{8-z}

where z is in the range of 0.1-4.2.

Preferably any alpha-phase sialon formed by the process of the invention has a composition characterised by the general formula:

M_{m/v}Si₁₂₋₍ₘ₊ₙ₎Alₘ₊ₙOₙN₁₆₋ₙ

where M is a metal cation having a valence v and where m and n indicate the replacement of (m+n) (Si—N) bonds by m(Al—N) and n(Al—O) bonds in the alpha-Si₃N₄ structure.

Preferably the sialon reactant mixture includes or comprises, by weight, about 2% to about 85% clay, about 5% to about 95% silicon metal and 2% to about 50% secondary aluminium source.

More preferably the sialon reactant mixture includes or comprises by weight 50% to 70% silicon metal, 20% to 40% clay, and 5 to 10% secondary aluminium source.

Alternatively the sialon reactant mixture includes or comprises, by weight, about 2% to about 85% clay, about 5% to about 95% silicon metal and 2% to about 50% aluminium nitride, the reactant mixture comprising up to substantially 50% of the starting materials and the one or more ceramic materials comprise up to substantially 75% of the starting materials.

In a further aspect of the invention there is provided a sialon ceramic formed in a pre-selected shape prepared substantially according to the above process.

In a further aspect the present invention comprises a method of preparing a sialon ceramic whether in a pre-selected shape or not substantially as described herein with reference to any one or more of the accompanying examples.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### DESCRIPTION OF THE DRAWINGS

FIG. 1: XRD pattern of product of Example 3.

FIG. 2: XRD pattern of product of Example 4.

FIG. 3: XRD pattern of product of Example 7.

FIG. 4: XRD pattern of product of Example 10.

FIG. 5: XRD pattern of product of Example 15.

FIG. 6: XRD pattern of product of Example 16.

### DETAILED DESCRIPTION OF THE INVENTION

The process of the present invention is a novel process for preparing sialon phases from fine powders of silicon metal, clay, (which may contain silica) an aluminium source and, for the production of some compositions, aluminium salts, yttia, calcia, magnesia, soda or lithia The clay may be dehydroxylated prior to use or a non-plastic aluminosilicate may be used. However retention of the clay in its natural plastic form will allow the mixture to be more readily formed into a desired shape prior to firing. The use of the clay material as a source of aluminium (as distinct from that added) and silicon for the production of sialon product allows the option of utilising the malleable properties of clay to be available. The product formed can thus be tailored for a specific use and can be produced very economically.

The beta-sialon formed by the process of the invention can have a z value of between 0.1 and 4.2. The z value equates to the aluminium content in the sialon. The raw materials may be blended by standard techniques such as ball milling or the like as will be known in the art. These raw materials are blended, formed into shapes by traditional methods of pressing, slip casting, or extruding and more advanced methods including isostatic pressing and injection moulding as will be known in the art, and then heated under a flowing nitrogen atmosphere to approximately 1250° C., held at this temperature for 4 to 8 hours, then heated to temperatures greater than 1300° C. at an appropriate rate, and held at this temperature for up to about 12 hours, although 6 and 8 hours is generally seen to be sufficient. Longer holding times may be used as will be known in the art. The nitrogen flow rate should be as low as possible, but sufficient to maintain an atmosphere with preferably about <0.5% oxygen and about ≦0.5% water vapour inside the furnace. The oxygen and water vapour content of the atmosphere should be kept to a minimum as they can affect the process by reacting with the silicon. During the reaction, the nitrogen from the furnace atmosphere becomes incorporated into the product via a nitridation reaction giving an increase in density. The product is primarily alpha- or beta-sialon, although O-sialon, mullite (3Al₂O₃.2SiO₂) and other sialon phases may also be formed.

Fluoride and chloride additives, if used, will promote the reaction to form the sialon structure, reducing reaction time and temperature and increasing sialon yield.

Some reaction occurs during the heating stage, and therefore the holding step for up to 12 hours is optional, however the bulk of the product is formed at 1250° C. as the fluoride reacts to form silicon fluoride. Holding the furnace at a temperature greater than 1250° C. is also optional but may be used to force the reaction to completion, or to sinter the body to obtain better densities. A heating rate of between 1° C. per minute and 5° C. per minute is considered suitable. The preferred temperature range is between 1150° C. and 1550° C. as at higher temperatures specialised and more expensive kilns may be required. The synthesis of alpha-sialon will proceed at temperatures as low as about 1000° C.

As will be readily apparent to a person skilled in the art, the type of furnace or kiln used must be able to maintain a controlled internal atmosphere at the temperatures required. Any type of furnace or kiln capable of this may be used.

The amorphous intermediate formed from kaolin clays is metakaolin. The amorphous intermediate will react with silicon and nitrogen to form silicon aluminium oxynitrides (sialons) under suitable conditions. The amorphous intermediate is formed at relatively low temperatures and is reactive at those temperatures. This facilitates the use of relatively low temperatures in the sialon forming process.

An example of the reaction to produce a beta-sialon from kaolin clay is shown in equation (1). In order to prepare a desired sialon the amount of each raw material must be balanced to provide the correct Si:Al:O:N ratio as will be known in the art.

Al₂O₃2SiO₂.2H₂O+aAlN+bSi+cN₂→4Si_{6-z}Al_{z}O_{z}N_{8-z}+2H₂O (1)

The equivalent process can be worked through to obtain an alpha-phase product similarly.

If the correct balance of raw materials is used then the production of sialon in the resultant ceramic is maximised. This balance of material can be calculated readily by a person skilled in the art and will depend largely on the composition of the clay used in the reaction.

The process of the present invention allows the manufacture of sialon compositions much more readily than established traditional methods. High z compositions may also be made by the process of the invention. Aluminium metal powder may be substituted for aluminium nitride in the starting mix.

The Industrial Research Limited et al PCT application (PCT/NZ95/00050, WO95/33700) discloses the synthesis of O-sialon from mixtures of clay and silicon.

Use of aluminium or non-oxide aluminium compounds in the process of the present invention allows further increases in the aluminium content of the sialon product to form alpha-sialon and beta-sialon or aluminium nitride polytypes. The process of the present invention is capable of producing products containing 100% sialon.

As will be apparent to a person skilled in the art a variety of clays may be used in the process. The preferred clays are hydrated clay minerals of which the kaolin clays are preferred. Other types of clay or aluminosilicates may also be used but most will contain a variety of impurities such as K, Na, Ca, Mg, and Fe together with the alumina silicate content. These impurities will affect the purity of the sialon product formed by the process unless the target sialon is alpha-sialon, in which case some of these impurities such as Na, Ca, and Mg can react and be absorbed into the alpha-sialon crystal structure.

Sintering aids such as Y₂O₃, CeO₂, MgO, and CaO can also be added to improve the density (see examples). In addition they can be added to the raw materials to accelerate the reaction, as can be seen in Example 2.

This process can also be used to fabricate composite ceramics, where a sialon is used to bond together grains of other ceramic materials such as silicon carbide (SiC), alumina (Al₂O₃), silicon nitride (Si₃N₄), sialon, zirconia (ZrO₂), silica (SiO₂) or coarse aluminium nitride (AlN). These bonded materials take little or no part in the reaction chemistry. They will preferably be coarser than the raw materials which react to form the bonding phase, and will preferably constitute between 1 and 70% of the starting mixture and thus of the fired ceramic. This additional ceramic material is bonded by a matrix of sialon formed by the other components in the starting mixture (i.e. the clay, silicon, aluminium nitride). The binding sialon will therefore constitute between 30% and 99% of the total composite ceramic.

As clay constitutes a significant proportion of the starting mixture, this enables simple and inexpensive forming techniques to be used. Slip casting, extruding and the like are examples of such techniques. As will be known in the art more advanced forming methods such as isostatic pressing, injection moulding and the like may also be used. Consequently there is a great flexibility in the shape and size of ceramic components that can be produced by the process of the present invention.

The reaction to form sialon is generally accompanied by an amount of shrinkage. However if sialon is used to bond another ceramic material and form a composite ceramic, as mentioned previously, this shrinkage can become negligible, allowing near-net size shapes to be formed. The shapes formed by the forming technique may be of any form desired.

The method of the present invention is capable of producing either ceramic bodies or sialon powder containing the sialon in a single firing step. To make the sialon powder the reaction proceeds without an emphasis on densification of the resultant ceramic. For example the starting materials can be shaped into pellets and reacted to form a ceramic pellet of sialon which is then ground into a powder. This sialon powder may then be used in other processes. For example the powder could be formed and sintered with sintering aids such as Y₂O₃, CaO, MgO, CeO₂ or the like to form fully dense ceramic bodies.

### EXAMPLE 1

### Synthesis of Beta-Sialon by Reacting Clay, Silicon, and Aluminium Nitride with Nitrogen

A stoichiometric mixture to form beta-sialon with z=0.5 from NZ China Clays Premium Grade Halloysite (Al₂O₃.2.4SiO₂.2.2H₂O) was weighed out according to the following equation:—

0.064(Al₂O₃.2.4SiO₂.2.2H₂O)+5.35Si+0.37AlN+2.57N₂→Si_{5.5}Al_{0.5}O_{0.5}N_{7.5}+0.14H₂O

| | |
|---|---|
| Wt % clay = | 10.0% |
| Wt % Si = | 81.7% |
| Wt % AlN = | 8.3% |
| Wt Gain = | 52.9% (Theoretical) |
| The mixture: | 1.303 g New Zealand China Clays Premium |
| | Grade Halloysite Clay |
| | 10.689 g Permascand 4D Silicon |
| | 1.084 g HC Starck Grade B Aluminium Nitride |

The 13 g mixture was blended by ball-milling with approximately 500 g of 10 mm diameter Si₃N₄ balls and 90 g of hexane in a 0.5 litre high density polyethylene (HDPE) bottle for 17 hours at approximately 150 rpm. The hexane solvent was removed by rotary evaporation. To break up lumps and form granules for uniform pressing the dry powder was passed through a 710 ml sieve and a disc 25.4 mm diameter, height 1.3 mm was formed in a die by uniaxial press at 8 MPa. This was placed in a balloon, air was removed by vacuum pump and it was sealed. It was pressed at 200 MPa in a Cold Isostatic Press (CIP), taken from the CIP, the balloon cut off, and the pellet was fired.

Twelve discs of varying composition (including the disc described above) were fired in a horizontal tube furnace (40 mm diameter tube) in a small alumina crucible under a flowing nitrogen atmosphere (approximately 200 ml.min⁻¹). They were heated to 110 C in 60 min., held at that temperature for 1 hour, then heated at 10 C.min⁻¹ to 1100 C, then heated at 1 C.min⁻¹ to 1250 C, held at that temperature for 4 hours, then heated at 1 C.min⁻¹ to 1350 C, held at that temperature for 8 hours. They were then cooled to 1000 C in 225 min, and set to cool to room temperature in 100 min., natural cooling lengthening this process.

The disc increased in mass by 39.6% during the firing, and an analysis of the products by X-ray powder diffraction (XRD) revealed beta-sialon with an approximately equal amount of alpha silicon nitride. The disc had an apparent porosity of 45%.

### EXAMPLE 2

### Synthesis of Beta-Sialon by Reacting Clay, Silicon, and Aluminium Nitride Plus 3% Yttia with Nitrogen. Demonstrates the Use of Yttria to Promote Synthesis

The mixture was prepared as for Example 1 with 3% yttrium oxide added (3% of the theoretical sialon yield)

| | |
|---|---|
| The mixture: | 0.91 g Clay, Silicon, and Aluminium Nitride |
| | from Example 1 |
| | 0.018 g HC Starck Grade C fine Yttrium Oxide |

This was mixed by hand in an agate pestle and mortar, then pressed and fired as described in Example 1.

The disc increased in mass by 37.5% during the firing, and an analysis of the products by X-ray powder diffraction (XRD) revealed primarily beta-sialon with a trace amount of alpha silicon nitride. The disc had an apparent porosity of 42%.

### EXAMPLE 3

### Synthesis of Beta-Sialon by Reacting Clay, Silicon, and Aluminium Nitride or Aluminium Metal Powder with Nitrogen

A stoichiometric mixture to form beta-sialon with z=2.72 by reacting Clay, Silicon, and Aluminium Nitride was weighed out according to the following equation:—

0.35(Al₂O₃.2.4SiO₂.2.2H₂O)+0.84Si+2.02AlN+1.637N₂→Si_{3.28}Al_{2.72}O_{2.72}N_{5.28}+0.77H₂O

| | |
|---|---|
| Wt % clay = | 39.7% |
| Wt % Si = | 27.3% |
| Wt % AlN = | 33% |
| Wt Gain = | 12.7% (Theoretical) |
| The mixture: | 7.040 g New Zealand China Clays Premium |
| | Grade Halloysite Clay |
| | 4.851 g Pennascand 4D Silicon |
| | 5.858 g HC Starck Grade B Aluminium Nitride |

A stoichiometric mixture to form beta-sialon with z=2.72 by reacting Clay, Silicon, and Aluminium Metal Powder was weighed out according to the following equation:—

0.35(Al₂O₃.2.4SiO₂.2.2H₂O)+0.84Si+2.02Al+2.64N₂→Si_{3.28}Al_{2.72}O_{2.72}N_{5.28}+0.77H₂O

| | |
|---|---|
| Wt % clay = | 44.7% |
| Wt % Si = | 30.8% |
| Wt % Al = | 24.5% |
| Wt Gain = | 27% (Theoretical) |
| The mixture: | 7.040 g New Zealand China Clays Premium |
| | Grade Halloysite Clay |
| | 4.851 g Permascand 4D Silicon |
| | 3.857 g BDH LR Grade Aluminium Powder |

The raw mixture was blended by ballmilling with approximately 500 g of 10 mm diameter Si₃N₄ balls and 90 g of hexane in a 0.5 litre high density polyethylene (HDPE) bottle for 17 hours at approximately 150 rpm. The hexane solvent was removed by rotary evaporation. The dry powder was passed through a 710 μm. sieve to granulate it.

The following compositions were made by mixing the two raw mixes

Beta-sialon z=2.72 from Si+CLAY+AlN (B49)

Beta-sialon z=2.72 from Si+ CLAY+AlN+Al (AlN:Al 3:1 by wt) (B50)

Beta-sialon z=2.72 from Si+ CLAY+AlN+Al (AlN:Al 1:1 by wt) (B51)

Beta-sialon z=2.72 from Si+ CLAY+AlN+Al (AlN:Al 1:3 by wt) (B52)

Beta-sialon z=2.72 from Si+ CLAY+Al (B53)

A disc of each composition (25.4 mm diameter, height 1.3 mm approximately) was formed in a die by uniaxial pressing at 8 MPa. This was placed in a balloon, air was removed by vacuum pump, it was sealed, and pressed at 200 MPa in a Cold Isostatic Press (CIP). It was taken from the CIP, the balloon cut off, and the disc fired.

Six discs of varying composition (including the five compositions listed above) were fired in a horizontal tube furnace (40 mm diam tube) in a small alumina crucible under a flowing nitrogen atmosphere (approximately 200 ml.min⁻¹). The discs were heated to 110 C in 60 min., held at that temperature for 1 hour, then heated at 10 C.min⁻¹ to 1100 C, then heated at 1 C.min⁻¹ to 1250 C, held at that temperature for 4 hours, then heated at 1 C.min⁻¹ to 1450 C, and held at that temperature for 8 hours. The discs were then cooled to 1000 C in 225 min, and set to cool to room temperature in 100 min., natural cooling lengthening this process.

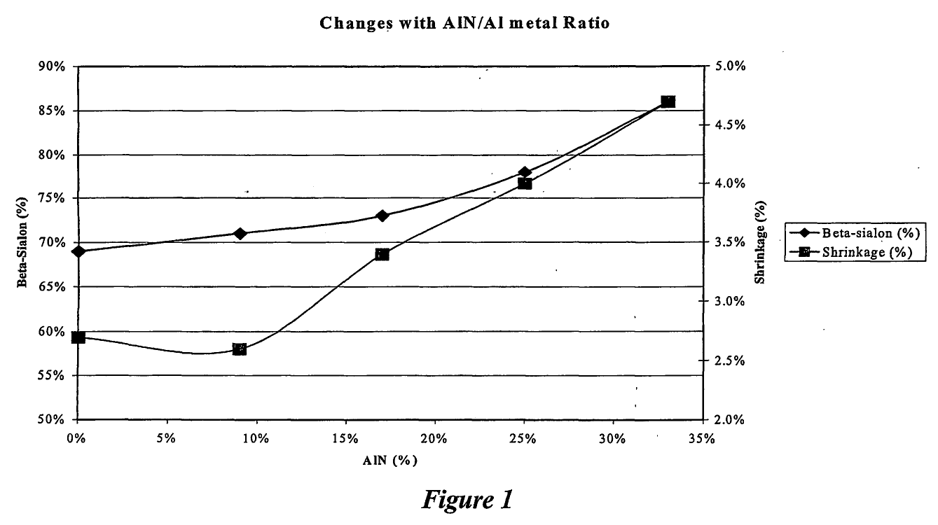

During the firing the discs all shrank between 4.7%(149) and 2.7%(B53) and increased in mass except B53 (−0.4% wt change). An analysis of the products by X-ray powder diffraction (XRD) revealed primarily beta-sialon with the proportion increasing with the initial aluminium nitride content (see FIG. 1).

### Example 4

### Synthesis of Lithium Alpha-Sialon by Reacting Clay, Silicon, Aluminium Nitride and Lithium Fluoride with Nitrogen

A stoichiometric mixture to form Lithium alpha-sialon with m=2, n=1 was weighed out according to the following equation:—

2LiF+0.13(Al₂O₃2.4SiO₂.2.2H₂O)+8.69Si+2.74AlN+6.13N₂→Li₂Si₉Al₃ON₁₅+F₂+0.28H₂O

| | |
|---|---|
| Wt % LiF = | 11.7% |
| Wt % clay = | 8.2% |
| Wt % Si = | 54.8% |
| Wt % AlN = | 25.3% |
| Wt Gain = | 28.9% (Theoretical) |
| The mixture: | 1.81 g Lithium Fluoride Hopkin &Williams |
| | General purpose Reagent |
| | 1.277 g New Zealand China Clays Premium |
| | Grade Halloysite Clay |
| | 8.513 g Permascand 4D Silicon |
| | 3.92 g HC Starck Grade B Aluminium Nitride |

The 15.5 g mixture was blended by ball-milling with approximately 500 g of 10 mm diameter Si₃N₄ balls and 90 g of hexane in a 0.5 litre high density polyethylene (HDPE) bottle for 17 hours at approximately 150 rpm. The hexane solvent was removed by rotary evaporation. The dry powder was passed through a 710 μm. sieve to granulate it. A ˜0.5 g sample was weighed into a small alumina crucible and fired.

Seven samples of varying composition (including the ˜0.5 g sample) were fired in a horizontal tube furnace (40 mm diam tube) in small alumina crucibles in a combustion boat under a flowing nitrogen atmosphere (approximately 200 ml.min⁻¹). They were heated to 1250 C at 5 C.min⁻¹ and held at that temperature for 4 hours. They were then set to cool to room temperature in 180 min., natural cooling lengthening this process.

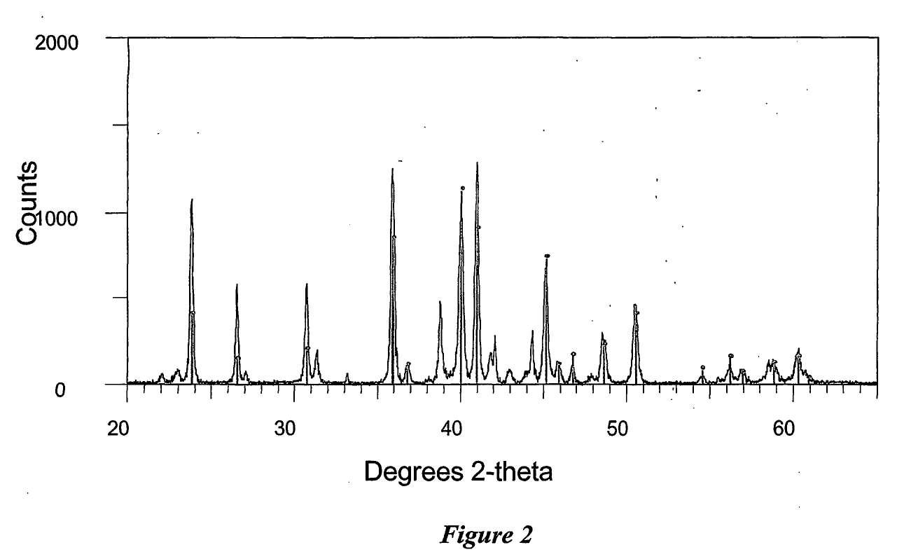

The sample increased in mass by 19.0% during the firing, and an analysis of the products by X-ray powder diffraction (XRD) (see FIG. 2) revealed that the major phase present was alpha-sialon with unit cell a=7.805 Å, c=5.668 Å, volume=299.0 Å³.

The minor phase present was O-sialon, unit cell a=8.991 Å, b=5.482 Å, c=4.880 Å, Volume=240.5 Å³. The XRD pattern is illustrated in FIG. 2, shown with the reference pattern for alpha-sialon (ICDD 33-261) with cell dimensions adjusted to fit the experimental peak positions. This indicates the presence of an alpha sialon structure The unit cell dimensions are different from calcium alpha-sialon (ICDD 33-261) indicating that lithium has stabilised the alpha sialon.

### Example 5

### Synthesis of a Range of Lithium Alpha-Sialons by Reacting Clay, Silicon, Aluminium Nitride and Lithium Fluoride with Nitrogen

Stoichiometric mixtures to form lithium alpha-sialon with m=2n and m=0.125, 0.25, 0.5, 0.75, 1, 1.5, 2, 2.5, 3, 3.5, 4, and 5 were calculated, weighed out, blended, granulated, and fired as described in Example 4.

Analyses of the products by X-ray powder diffraction (XRD) revealed primarily alpha-sialons with small amounts of silicon and O-sialons (low m value mixtures) and small amounts of O-sialons and aluminium nitride. The alpha-sialon content increased with m value, and then declined for “m=4” and “m=5”.

The alpha-sialon cell volume determined by X-ray diffraction increased with the m value (the nominal lithium content).

### EXAMPLE 6

### Synthesis of Lithium Alpha-Sialon Ceramic by Reacting Clay, Silicon, and Aluminium Nitride and Lithium Carbonate with Nitrogen and Sintering at 1500 C

A stoichiometric mixture to form Lithium alpha-sialon with m=3, n=1.5 was prepared and a disc made according to the method outlined in Example 4.

Twelve discs of varying composition (including the disc described above) were fired in a horizontal tube furnace (40 mm diam tube) in a small alumina crucible under a flowing nitrogen atmosphere (approximately 36 ml.min⁻¹). They were heated at 5 C.min⁻¹ to 1200° C., held at that temperature for 8 hours, then heated at 2.5 C.min⁻¹ to 1500° C., and held at that temperature for 8 hours. They were then cooled to 1200 C at 2.5° C.min⁻, and set to cool to room temperature at 5° C.min⁻¹., natural cooling lengthening this process.

The disc sample increased in mass by 9.2% during the firing but did not change size. It had an apparent porosity of 41.8%. An analysis of the products by X-ray powder diffraction (XRD) revealed alpha-sialon with unit cell a=7.801 Å, c=5.672 Å, Volume=299.0 Å³. The only other crystalline phase present was a trace (1%) of O-sialon.

### Example 7

### Synthesis of Sodium Alpha-Sialon by Reacting Clay, Silicon, and Aluminium Nitride and Sodium Fluoride with Nitrogen

A stoichiometric mixture to form sodium alpha-sialon with m=2, n=1 was weighed out according to the following equation:—

2NaF+0.13(Al₂O₃.2.4SiO₂.2.2H₂O)+8.69Si+2.74AlN+6.13N₂→Na₂Si₉Al₃ON₁₅+F₂+0.28H₂O

| | |
|---|---|
| Wt % NaF = | 17.6% |
| Wt % clay = | 7.7% |
| Wt % Si = | 51.2% |
| Wt % AlN = | 23.6% |
| Wt Gain = | 26.9% (Theoretical) |
| The mixture: | 2.77 g Sodium Fluoride BDH AR 99% |
| | 1.209 g New Zealand China Clays Premium |
| | Grade Halloysite Clay |
| | 8.062 g Permascand 4D Silicon |
| | 3.712 g HC Starck Grade B Aluminium Nitride |

The 15.75 g mixture was blended by ball-milling with approximately 500 g of 10 mm diameter Si₃N₄ balls and 90 g of hexane in a 0.5 litre high density polyethylene (HDPE) bottle for 17 hours at approximately 150 rpm. The hexane solvent was removed by rotary evaporation. The dry powder was passed through a 710 μm. sieve to granulate it. A ˜1.0 g powder sample was weighed into a small alumina crucible and fired.

Five powder samples of varying composition were fired in a horizontal tube furnace (40 mm diam tube) in small alumina crucibles in a combustion boat under a flowing nitrogen atmosphere (approximately 200 ml.min⁻¹). They were heated to 1300 C at 2.6 C.min⁻¹ and held at that temperature for 2 hours. They were then set to cool to room temperature in 100 min., natural cooling lengthening this process.

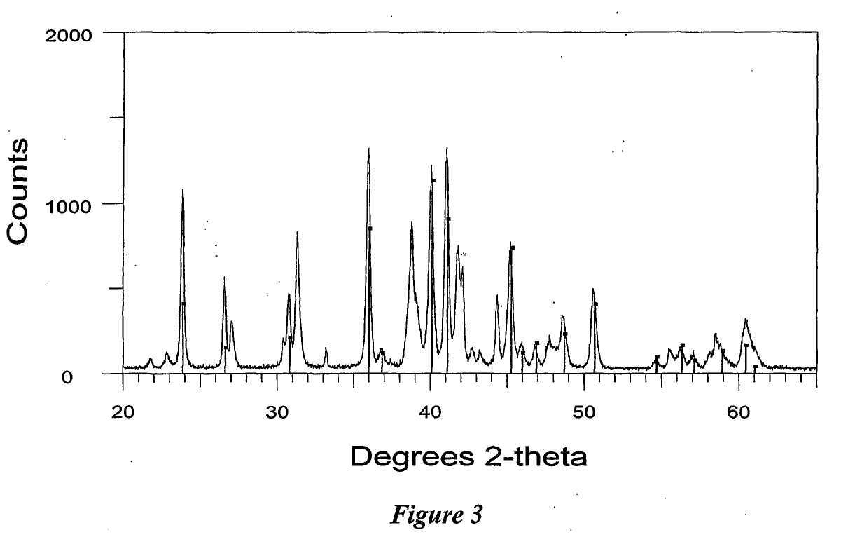

The sample increased in mass by 11.6% during the firing, and an analysis of the products by X-ray powder diffraction (XRD) (see FIG. 3) revealed that the major phase present was alpha-sialon with unit cell a=7.799 Å, c=5.673 Å, Volume=298.7 Å³. Beta-sialon was present as a minor phase, with traces of silicon and O-sialon. The XRD pattern is illustrated in FIG. 3, shown with the reference pattern for alpha-sialon (ICDD 33-261) with cell dimensions adjusted to fit the experimental peak positions. This indicates presence of an alpha sialon structure. The unit cell dimensions are different from calcium alpha-sialon (ICDD 33-261) indicating that sodium has stabilised the alpha sialon.

### EXAMPLE 8

### Synthesis of Calcium Alpha-Sialon by Reacting Clay, Silicon, and Aluminium Nitride and Calcium Hydroxide with Nitrogen

A stoichiometric mixture to form Calcium alpha-sialon with m 1.5, n=0.75 was prepared

| | |
|---|---|
| The mixture: | 1.88 g Calcium Hydroxide BDH AR 98.0% |
| | 0.931 g New Zealand China Clays Premium |
| | Grade Halloysite Clay |
| | 9.062 g Permascand 4D Silicon |
| | 2.858 g HC Starck Grade B Aluminium Nitride |

The 14.7 g mixture was blended by ball-milling with approximately 500 g of 10 mm diameter Si₃N₄ balls and 90 g of isopropyl alcohol in a 0.5 litre high density polyethylene (HDPE) bottle for 17 hours at approximately 150 rpm. The isopropyl alcohol solvent was removed by rotary evaporation. The dry powder was passed through a 710 μm. sieve to granulate it and a disc made according to the method outlined in Example 1.

Six disc samples of varying composition were fired in a horizontal tube furnace (40 mm diam tube) in a combustion boat under a flowing nitrogen atmosphere (approximately 50 ml.min⁻¹). They were heated to 1450 C at 2 C.min⁻¹ and held at that temperature for 8 hours. They were then set to cool to room temperature in 180 min, natural cooling lengthening this process.

The sample increased in mass by 33.6% during the firing, and an analysis of the products by X-ray powder diffraction (XRD) revealed that the major phase present was alpha-sialon and the minor phase present was beta-sialon (9%). The apparent porosity was 20%.

### EXAMPLE 9

### Synthesis of Calcium Alpha-Sialon by Reacting Clay, Silicon, and Aluminium Nitride and Calcium Fluoride with Nitrogen

A stoichiometric mixture to form Calcium alpha-sialon with m=1.5, n=0.75 was prepared

| | |
|---|---|
| The mixture: | 1.98 g Calcium Fluoride BDH LR >99.0% |
| | 0.931 g New Zealand China Clays Premium |
| | Grade Halloysite Clay |
| | 9.062 g Permascand 4D Silicon |
| | 2.858 g HC Starck Grade B Aluminium Nitride |

The 14.8 g mixture was blended by ball-milling with approximately 500 g of 10 mm diameter Si₃N₄ balls and 90 g of isopropyl alcohol in a 0.5 litre high density polyethylene (HDPE) bottle for 17 hours at approximately 150 rpm. The isopropyl alcohol solvent was removed by rotary evaporation. The dry powder was passed through a 710 μm. sieve to granulate it and a disc made according to the method outlined in Example 1.

Fourteen discs of varying composition (including the composition listed above) were fired in a horizontal tube furnace (40 mm diam tube) in a small alumina crucible under a flowing nitrogen atmosphere (approximately 140 ml.min⁻¹) They were heated to 110 C at 5 C.min⁻¹, held at that temperature for 1 hour, then heated at 5 C.min⁻¹ to 1100 C, then heated at 1 C.min⁻¹ to 1250 C, held at that temperature for 2 hours, then heated at 1 C.min⁻¹ to 1350 C, held at that temperature for 2 hours, then heated at 1 C.min⁻¹ to 1450 C, held at that temperature for 10 hours. They were then cooled at 2.5 C.min⁻¹ to 1100 C, and set to cool to room temperature at 5 C.min⁻¹, natural cooling lengthening this process.

The sample increased in mass by 35.8% during the firing and shrank by 3.6%. An analysis of the products by X-ray powder diffraction (XRD) revealed that the major phase present was alpha-sialon and the minor phase present was beta-sialon (5%). The apparent porosity was 28%.

### Example 10

### Synthesis of Calcium Alpha-Sialon by Reacting Clay, Silicon, and Aluminium Nitride and Calcium Fluoride with Nitrogen

A stoichiometric mixture to form Calcium alpha-sialon with m=1.5, n=0.75 was prepared as described in Example 9.

Eight discs of varying composition (including the composition listed above) were fired in a horizontal tube furnace (40 mm diam tube) in a small alumina crucible under a flowing nitrogen atmosphere (approximately 80 ml.min⁻¹). They were heated to 110 C at 5 C.min⁴¹, held at that temperature for 1 hour, then heated at 5 C.min⁻¹ to 1100 C, then heated at 1 C.min⁻¹ to 1250 C, held at that temperature for 2 hours, then heated at 1 C.min⁻¹ to 1350 C, held at that temperature for 2 hours, then heated at 1 C.min⁻¹ to 1450 C, held at that temperature for 2 hours then heated at 1 C.min⁻¹ to 1550 C and held at that temperature for 8 hours. They were then cooled at 2.5 C.min⁻¹ to 1350 C, and held at that temperature for 8 hours. They were then cooled at 2.5 C.min⁻¹ to 1100 C, and set to cool to room temperature at 5 C.min⁻¹, natural cooling lengthening this process.

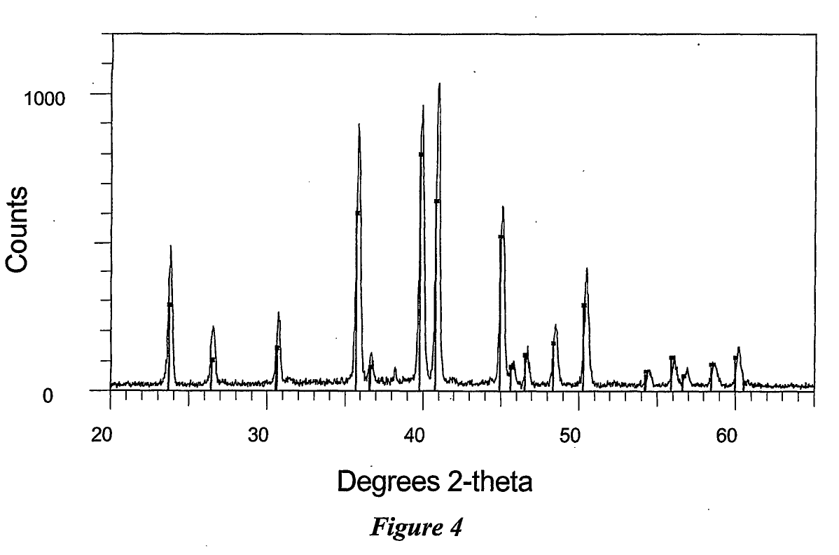

The sample increased in mass by 8.1% during the firing and shrank by 9.3%. An analysis of the products by X-ray powder diffraction (XRD) revealed that the only crystalline phase present was alpha-sialon. The apparent porosity was 33%. The XRD pattern is illustrated in FIG. 4, shown with the reference pattern for alpha-sialon (ICDD 33-261) with cell dimensions adjusted to fit the experimental peak positions. This indicates the presence of an alpha sialon structure. The unit cell dimensions are different from calcium alpha-sialon (ICDD 33-261) indicating a different calcium content.

### EXAMPLE 11

### Synthesis of Calcium Alpha-Sialon by Reacting Clay, Silicon, and Aluminium Nitride and Calcium Fluoride with Nitrogen

Demonstrates the use of Yttria to Promote Synthesis and Aid Sintering.

A stoichiometric mixture to form Calcium alpha-sialon with m=1.5, n=0.75 was prepared as described in Example 9 with the addition of 5% yttria (calculated as a percentage of the theoretical sialon yield). It was prepared and fired as described in Example 9.

The sample increased in mass by 24.3% during the firing and shrank by 8.2%. An analysis of the products by X-ray powder diffraction (XRD) revealed that the major phase present was alpha-sialon and the minor phase present was beta-sialon (12%). The apparent porosity was 3.5%.

### EXAMPLE 12

### Reaction Bonding Silicon Carbide with Sodium Alpha-Sialon by Reacting Nitrogen with Clay, Silicon, and Aluminium Nitride and Sodium Fluoride, Mixed with Silicon Carbide

A sialon precursor mixture to form sodium alpha-sialon with m=5, n=2.5 was prepared as described in Example 7. This was added to silicon carbide as follows

40% sialon precursor mixture as described above

40% Navarro 80-grit silicon carbide (SiC)

20% Navarro 220-grit silicon carbide (SiC)

The 2 g mixture was blended by hand in an agate mortar. A 1.0 g disc (19 mm diam.) was formed from the powder mixture and fired as in Example 7.

Six 1 g pressed disc samples of varying composition were fired in a horizontal tube furnace (40 mm diam tube) in an alumina combustion boat under a flowing nitrogen atmosphere (approximately 30 ml.min⁻¹). They were heated to 1200° C. at 5 C.min⁻¹ and held at that temperature for 4 hours. They were then set to cool to room temperature in 240 min., natural cooling lengthening this process.

An analysis of the products by X-ray powder diffraction (XRD) revealed silicon carbide with alpha sialon and O-sialon. The ratio of alpha sialon to O-sialon was 4:1.

The bulk density and open porosity of the fired pellet were measured by immersion in water, the shrinkage was measured across the diameter of the disc:

| bulk density = | 2.38 g · cm⁻³ |
|---|---|
| apparent porosity = | 24.9% |
| shrinkage = | 0.8% |

### EXAMPLE 13

### One Step Synthesis and Sintering of Calcium Alpha-Sialon by Reacting Clay, Silicon, and Aluminium Nitride and Calcium Fluoride with Nitrogen

The stoichiometric mixture to form Ca α′SiAlON with m=1.5, n=0.75 was weighed out as described in Example 9 according to the following equation:—

Silicothermal reduction and nitzidation to form Ca_{0.75}Si_{9.75}Al_{2.25}O_{0.75}N_{1.5}

0.75CaCO₃+1.125Al₂O₃2.4SiO₂.2.2H₂O+15.835→Ca_{0.75}Si_{9.75}Al_{2.25}O_{0.75}N_{1.5}+8.78SiO+0.75CO₂+2.475H₂O

The 20 g mixture was blended as described in Example 9 and a powder for a 1 g pellet was prepared by taking 0.97 g of the mixture with 0.03 g of cerium oxide (Aldrich) and mixing by hand with an agate pestle and mortar. The dry powder was uniaxially pressed to 8 MPa in a 13 mm diameter steel die to form pellets approximately 1.0 g. in weight.

The pellet was fired in a horizontal tube furnace (40 mm diam tube) in a small alumina crucible under a flowing nitrogen atmosphere (approximately 10 ml.min⁻¹g⁻¹) at 5° C.min⁻¹ to 110° C., held at that temperature for 1 hour, then heated at 5° C.min¹ to 1100° C., then heated at 1° C.min⁻¹ to 1200° C. and held at that temperature for 8 hours, then heated at 1° C.min⁻¹ to 1350° C. and held at that temperature for 8 hours, then heated at 1° C.min⁻¹ to 1450° C. and held at that temperature for 8 hours, then heated at 1° C.min⁻¹ to 1550° C. and held at that temperature for 8 hours, then cooled at 10° C.min⁻¹ until the natural cooling rate of the furnace was slower than 10° C.min⁻¹ after which it was allowed to cool to room temperature and the sample recovered.

The pellet increased in mass by 18.4% during the firing, and an analysis of the products by X-ray powder diffraction (XRD) revealed primarily Ca alpha-sialon with a minor amount of beta-sialon. The shrinkage was 12.6% and apparent porosity 1.6%.

### Example 14

### Synthesis of Beta-Sialon by Reacting Clay, Silicon, and Aluminium Nitride and Aluminium Chloride with Nitrogen

A stoichiometric mixture to form beta-sialon with z=2.72 was prepared

| | |
|---|---|
| The mixture: | 19.062 g Aluminium Chloride BDH LR |
| | 7.040 g New Zealand China Clays Premium |
| | Grade Halloysite Clay |
| | 4.851 g Permascand 4D Silicon |
| | 0.0 g HC Starck Grade B Aluminium Nitride |

The 30.95 g mixture was blended by ball-milling with approximately 500 g of 10 mm diameter Si₃N₄ balls and 90 g of isopropyl alcohol in a 0.5 litre high density polyethylene (HDPE) bottle for 17 hours at approximately 150 rpm. The isopropyl alcohol solvent was removed by rotary evaporation. The dry powder was passed through a 710 μm. sieve to granulate it and a disc made according to the method outlined in Example 1.

Six discs of varying composition (including the composition listed above) were fired in a horizontal tube furnace (40 mm diam tube) in a small alumina crucible under a flowing nitrogen atmosphere (approximately 140 ml.min⁻¹). They were heated to 110° C. at 1° C.min⁻¹, held at that temperature for 1 hour, then heated at 10° C.min⁻¹ to 1100° C., then heated at 1° C.min⁻¹ to 1250° C., held at that temperature for 2 hours, then heated at 1° C.min⁻¹ to 1350° C., held at that temperature for 4 hours, then heated at 1° C.min⁻¹ to 145° C., held at that temperature for 8 hours. They were then cooled at 2° C.min⁻¹ to 1100° C., and set to cool to room temperature at 5° C.min⁻¹, natural cooling lengthening this process.

The sample decreased in mass by 50% during the firing and shrank by 23%. An analysis of the products by X-ray powder diffraction (XRD) revealed that the major phases present were beta-sialon and X-phase and the minor phase present was alumina (15%). The apparent porosity was 58%.

### EXAMPLE 15

### Synthesis of Lithium Substituted O-Sialon by Reacting Clay, Silicon, and Aluminium Nitride and Lithium Fluoride with Nitrogen at 1000 C

A stoichiometric mixture to form Lithium alpha-sialon with m=5, n=7-2.5 was prepared according to the method outlined in Example 4.

Eleven powder samples of varying composition, each approximately 0.3 g, (including the mixture described above) were fired in a horizontal tube furnace (40 mm diam tube) in small alumina crucibles under a flowing nitrogen atmosphere (approximately 10 ml.min⁻¹). They were heated at 5 C.min⁻¹ to 1000 C and held at that temperature for 4 hours. They were then cooled to room temperature at 5 C.min⁻¹., natural cooling lengthening this process.

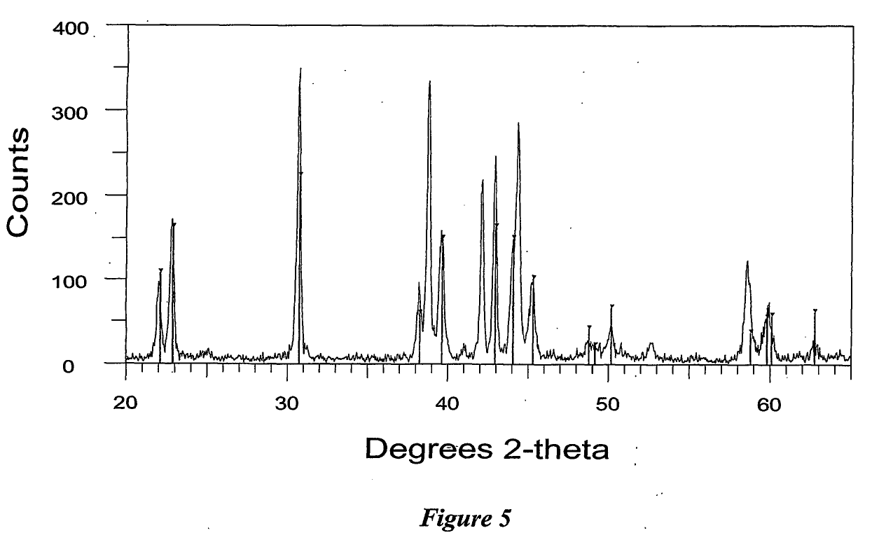

The sample (LRun19L11 15 Dec. 2000) decreased in mass by 4.2% during the firing. An analysis of the products by X-ray powder diffraction (XRD) revealed O-sialon with unit cell a=9.045 Å, b=5.645 Å, c=4.888 Å, Volume=241.6 Å³ The XRD pattern is illustrated in FIG. 5, shown with the reference pattern for O-sialon (ICDD 42-1492) with cell dimensions adjusted to fit the experimental peak positions. The other crystalline phase present was an equal quantity of aluminium nitride.

### EXAMPLE 16

### Synthesis of Sodium Substituted O-Sialon by Reacting by, Silicon, and Aluminium Nitride and Sodium Fluoride with Nitrogen at 1000 C

A stoichiometric mixture to form Sodium alpha-sialon with m=5, n=2.5 was prepared according to the method outlined in Example 7.

Six powder samples of varying composition, each approximately 0.5 g, (including the mixture described above) were fired in a horizontal tube furnace (40 mm diam tube) in small alumina crucibles under a flowing nitrogen atmosphere (approximately 100 ml.min⁻¹). They were heated at 5 C.min⁻¹ to 1150 C and held at that temperature for 4 hours. They were then cooled to room temperature at 5 C.min⁻¹., natural cooling lengthening this process.

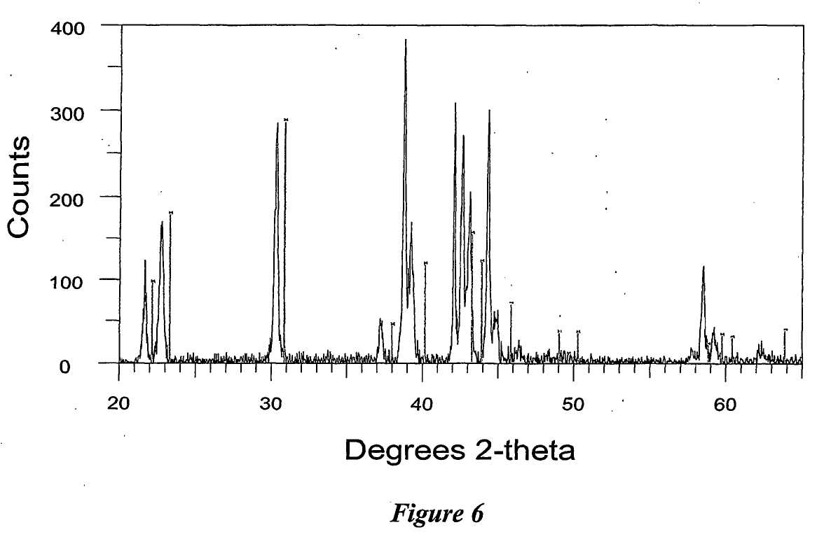

The sample (DRun1D4 30 Nov. 2001) decreased in mass by 19.2% during the firing. An analysis of the products by X-ray powder diffraction (XRD) revealed O-sialon as the major phase with unit cell a=9.099 Å, b=5.608 Å, c=4.920 Å, volume=251.1 Å³. The XRD pattern is shown in FIG. 6 with the reference pattern for O-sialon (ICDD 42-1492), with cell dimensions not adjusted to fit the experimental peak positions, illustrating the shift caused by the substituted sodium. Aluminium nitride was the other crystalline phase present, making up approximately 40% of the sample.

The foregoing describes the invention including preferred forms thereof. Alterations and modifications as will be obvious to those skilled in the art are intended to be incorporated within the scope of the invention.

1-75. (cancelled)

76. A process for the production of sialon ceramic comprising or including the steps of:
(I) preparing a sialon reactant mixture including or comprising:
a) silicon metal,
b) clay, and
c) a secondary aluminium source;
(II) heating the reactant mixture in an atmosphere containing nitrogen gas to a temperature sufficient to substantially react the silicon metal, the secondary aluminium source and the nitrogen with the clay to form or to contribute to the forming of the sialon product,
wherein the clay participates in the reaction as a source of aluminium and silicon.

77. A process as claimed in claim 76 where the secondary aluminium source has a sufficiently fine particle size such that substantially all the secondary aluminium source reacts in the process.

78, A process as claimed in claim 77 where all the secondary aluminium source reacts within a time period of 8 hours.

79. A process as claimed in claim 76 wherein the secondary aluminium source is one or more of aluminium metal, aluminium nitride, non-oxide aluminium salts.

80. A process as claimed in claim 79 wherein the non-oxide aluminium salts may be aluminium chloride or aluminium fluoride.

81. A process as claimed in claim 76 wherein all of the reactant mixture constituents are introduced as fine powders.

82. A process as claimed in claim 76 wherein the sialon product contains one or more of the sialon phases including alpha-, beta-O-, X-phases, and AlN polytype sialons.

83. A process as claimed in claim 82 wherein the sialon product is substantially all in the alpha-phase.

84. A process as claimed in claims 83 wherein the process includes addition of one or more alpha-phase stabilising cation sources, in order to promote the formation of the alpha-phase relative to any other sialon product phase.

85. A process as claimed in claim 84 wherein the one or more cation sources include non-oxide salts of yttrium, calcium, magnesium, sodium and lithium.

86. A process as claimed in claim 85 wherein the one or more cation sources are or include lithium chloride and/or lithium fluoride.

87. A process as claimed in claim 84 wherein the ratio of sialon phases may be controlled by control of one or more of:
i) cation identity,
ii) relative cation amount,
iii) temperature,
iv) duration and/or conditions of the exposure of the mixture to heat and/or nitrogen gas.

88. A process as claimed in claim 84 wherein following addition of the one or more alpha-phase stabilising cation sources, the sialon product is substantially all in the alpha-phase.

89. A process as claimed in claim 76 wherein the mixture is heated to between about 1000° C. and about 1700° C.

90. A process as claimed in claim 89 wherein the mixture is heated at 1300° C.

91. A process as claimed in claims 90 wherein the components are heated at a rate of between substantially about 1° C. and about 20° C. per minute.

92. A process as claimed in claim 91 wherein more preferably the components are heated between about 1.5° C. and about 2.5° C. per minute.

93. A process as claimed in claim 92 wherein the reactant mixture is held at the required temperature for up to about 12 hours.

94. A process as claimed in claim 93 wherein most preferably the reactant mixture is held at the required temperature for up to about 8 hours.

95. A process as claimed in claim 82 wherein the process may include the addition of a source of fluoride or chloride ions to the reactant mixture to promote the formation of the alpha-phase.

96. A process as claimed in claim 83 wherein the process may include the addition of a source of fluoride or chloride ions and use of a reduced temperature and/or reaction time, in order to promote the formation of the alpha-phase.

97. A process as claimed in claim 96 wherein the source of the fluoride or chloride ions is aluminium fluoride or aluminium chloride respectively, which also acts as the secondary aluminium source.

98. A process as claimed claim 96 wherein the source of the fluoride or chloride ions is calcium-, magnesium-, sodium-, or lithium fluoride, and which also acts as the one or more alpha-phase stabilising cation sources.

99. A process as claimed in claim 76 wherein the process includes mixing the reactant mixture with one or more sintering aids.

100. A process as claimed in claim 99 wherein the one or more sintering aids are selected from oxides or non-oxide salts of yttrium, calcium, magnesium, cerium, sodium, potassium and/or lithium.

101. A process as claimed in claim 100 wherein the one or more sintering aids are selected from the non-oxide salts of yttrium, calcium, magnesium, cerium, sodium, potassium and/or lithium, and wherein the one or more sintering aids may also act as the one or more alpha-phase stabilising cation sources.

102. A process as claimed in claim 76 wherein the process includes the addition of one or more ceramic materials having an average particle size coarser than other species present which react in the process, which remain substantially unreacted throughout the reaction.

103. A process as claimed in claim 102 wherein the one or more ceramic materials take the form of coarse granules and/or particles and/or fibres, and may include one or more of silicon carbide, alumina, silicon nitride, sialon, zirconia, silica or aluminium nitride.

104. A process as claimed in claim 103 wherein the one or more ceramic materials will constitute up to about 75% by weight of the mixture.

105. A process as claimed in claim 104 wherein the one or more ceramic materials will constitute between about 40% and about 75% by weight of the mixture.

106. A process as claimed in claim 76 wherein the atmosphere is substantially pure nitrogen, a hydrogen/nitrogen mixture or ammonia.

107. A process as claimed in claim 106 wherein the atmosphere is a flowing gas atmosphere.

108. A process as claimed in claim 107 wherein the gas is N₂ and it has an oxygen content of about <0.5% and a water vapour content of <0.5%.

109. A process as claimed in claim 76 wherein the clay is an hydrated clay mineral.

110. A process as claimed in claim 109 wherein the clay is a hydrated aluminosilicate such as a kaolin clay.

111. A process as claimed in claim 110 wherein the clay contains a free silica component.

112. A process as claimed in claim 76 wherein the clay is dehydroxylated or an aluminosilicate product of dehydroxylation such as mullite, or an aluminosilicate mineral such as molochite, silimanite or kyanite.

113. A process as claimed in claim 112 wherein the clay is dehydroxylated by including a pre-step of dehydroxylating the clay into the process of the invention.

114. A process as claimed in claim 76 wherein the clay content in the starting mixture is between about 2 and 85% by weight.

115. A process as claimed in claim 114 wherein the clay content in the starting mixture is between about 5 and 85% by weight.

116. A process as claimed in claim 115 wherein the clay content in the starting mixture is between 20 and 30% by weight.

117. A process as claimed in claim 76 wherein any beta-phase sialon formed by the process of the invention is within the composition range:
Si_{6-z}Al_{z}O_{z}N_{8-z}
where z is in the range of 0.1-4.2.

118. A process as claimed in claim 76 wherein any alpha-phase sialon formed by the process of the invention has a composition characterised by the general formula:
M_{m/v}Si₁₂₋₍ₘ₊ₙ₎Alₘ₊ₙOₙNi₁₆₋ₙ
where M is a metal cation having a valence v and where m and n indicate the replacement of (m+n) (Si—N) bonds by m(Al—N) and n(Al—O) bonds in the alpha-Si₃N₄ structure.

119. A process as claimed in claim 76 wherein the sialon reactant mixture includes or comprises, by weight, about 2% to about 85% clay, about 5% to about 95% silicon metal and 2% to about 50% secondary aluminium source.

120. A process as claimed in claim 119 wherein the sialon reactant mixture includes or comprises, by weight, about 5% to about 85% clay, about 5% to about 95% silicon metal and 2% to about 50% secondary aluminium source.

121. A process as claimed in claim 120 wherein the sialon reactant mixture includes or comprises by weight 50% to 70% silicon metal, 20% to 40% clay, and 5 to 10% secondary aluminium source.

122. A process as claimed in claim 76 wherein the sialon reactant mixture includes or comprises, by weight, about 2% to about 85% clay, about 5% to about 95% silicon metal and 2% to about 50% aluminium nitride, and wherein the reactant mixture comprises up to substantially 50% of the starting materials and the one or more ceramic materials (when present) comprise up to substantially 75% of the starting materials.

123. A process as claimed in claim 122 wherein the sialon reactant mixture includes or comprises, by weight, about 5% to about 85% clay, about 5% to about 95% silicon metal and 2% to about 50% aluminium nitride, and wherein the reactant mixture comprises up to substantially 50% of the starting materials and the one or more ceramic materials (when present) comprise up to substantially 75% of the starting materials.

124. A process as claimed in claim 76 wherein the product of the process is a sialon powder.

125. A process as claimed in claim 76 wherein the product is a sialon ceramic body, of a pre-selected shape.

126. A process claimed in claim 125 wherein the shape is pre-selected by the use of a shape selecting technique such as pressing, slip casting, extruding, isostatic pressing or injection moulding.

127. A sialon ceramic prepared substantially according to claim 76.

128. A method of forming a sialon ceramic in a pre-selected shape, comprising or including the steps of
(I) preparing a sialon reactant mixture including or comprising:
a. silicon metal,
b. clay, and
c. a secondary aluminium source;
(II) shaping the sialon reactant mixture in accordance with the pre-selected shape,
(III) heating the reactant mixture in an atmosphere containing nitrogen gas to a temperature sufficient to substantially react the silicon metal, the secondary aluminium source and the nitrogen with the clay to form or to contribute to the forming of the sialon product, wherein the clay participates in the reaction as a source of aluminium and silicon.

129. A process as claimed in claim 128 wherein the shaping step (II) involves shaping the reactant mixture by a technique such as pressing, slip casting, extruding, isostatic pressing, injection moulding.

130. A process as claimed in claim 128 wherein the secondary aluminium source is one of more of aluminium metal, aluminium nitride, non-oxide aluminium salts.

131. A process as claimed in claim 130 wherein the non-oxide aluminium salts may be aluminium chloride or aluminium fluoride.

132. A process as claimed in claim 128 wherein all of the reactant mixture constituents are introduced as fine powders, and at least substantially all of the secondary aluminium source reacts.

133. A process as claimed in claim 128 wherein the sialon product contains one or more of the sialon phases (which may include for example, alpha-, beta-, O-, X-phase, and AlN polytype sialons).

134. A process as claimed in claim 133 wherein the sialon product is substantially all in the alpha-phase.

135. A process as claimed in claim 133 wherein the process includes addition of one or more alpha-phase stabilising cation sources selected from non-oxide salts of yttrium, calcium, magnesium, sodium and lithium in order to increase the yield of the alpha-phase relative to any other sialon product phase.

136. A process as claimed in claim 135 wherein following addition of the one or more alpha-phase stabilising cation sources, the sialon product is substantially all in the alpha-phase.

137. A process as claimed in claim 136 wherein the ratio of sialon phases may be controlled by control of one or more of:
i) cation identity,
ii) relative cation amount,
iii) temperature,
iv) duration and/or conditions of the exposure of the mixture to heat and/or nitrogen gas.

138. A process as claimed in claim 128 wherein the mixture is heated to between about 1000° C. and about 1700° C., at a rate of between substantially about 1° C. and about 20° C. per minute.

139. A process as claimed in claim 138 wherein most preferably the reactant mixture is held at the required temperature for up to about 8 hours.

140. A process as claimed in claim 133 wherein the process includes the addition of a source of fluoride or chloride ions to the reactant mixture and/or a reduced temperature and/or reaction time, in order to promote the formation of the alpha-phase.

141. A process as claimed in claim 128 wherein the process includes mixing the reactant mixture with one or more sintering aids, selected from oxides or non-oxide salts of yttrium, calcium, magnesium, cerium, sodium, potassium and/or lithium.

142. A process as claimed in claim 128 wherein the process includes the addition of one or more ceramic materials to the reactant mixture which remain substantially unreacted throughout the reaction.

143. A process as claimed in claim 142 wherein the one or more ceramic materials may be one or more of silicon carbide, alumina, silicon nitride, sialon, zirconia, silica or aluminium nitride.

144. A process as claimed in claim 128 wherein the clay is an hydrated clay mineral.

145. A process as claimed in claim 128 wherein the clay is dehydroxylated or an aluminosilicate product of dehydroxylation such as mullite, or an aluminosilicate mineral such as molochite, silimanite or kyanite.

146. A process as claimed in claim 128 wherein the clay content in the starting mixture is between about 2 and 85% by weight and more preferably between 20 and 30% by weight.

147. A process as claimed in claim 146 wherein the clay content in the starting mixture is between about 5 and 85% by weight and more preferably between 20 and 30% by weight.

148. A process as claimed in claim 128 wherein any beta-phase sialon formed by the process of the invention is within the composition range:
Si_{6-z}Al_{z}O_{z}N_{8-z}
where z is in the range of 0.14.2.

149. A process as claimed in claim 128 wherein any O-sialon formed by the process of the invention is within the composition range:
Si_{2-X}Al_{X}O_{1+X}N_{2-X}
where x is in the range of 0 to 0.4

150. A process as claimed in claim 128 wherein any alpha-phase sialon formed by the process of the invention has a composition characterised by the general formula:
M_{n/v}Si_{(M+n)}Al₍ₘ₊ₙ₎OₙN₁₆₋ₙ
where M is a metal cation having a valence v and where m and n indicate the replacement of (m+n) (Si—N) bonds by m(Al—N) and n(Al—O) bonds in the alpha-Si₃N₄ structure.

151. A process as claimed in claim 128 wherein the sialon reactant mixture includes or comprises by weight 50% to 70% silicon metal, 20% to 40% clay, and 5 to 10% secondary aluminium source.

152. A process as claimed in claim 128 wherein the sialon reactant mixture includes or comprises, by weight, about 2% to about 85% clay, about 5% to about 95% silicon metal and 2% to about 50% aluminium nitride, and wherein the reactant mixture comprises up to substantially 50% of the starting materials and the one or more ceramic materials comprise up to substantially 75% of the starting materials.

153. A process as claimed in claim 152 wherein the sialon reactant mixture includes or comprises, by weight, about 2% to about 85% clay, about 5% to about 95% silicon metal and 5% to about 50% aluminium nitride, and wherein the reactant mixture comprises up to substantially 50% of the starting materials and the one or more ceramic materials comprise up to substantially 75% of the starting materials.

154. A sialon ceramic formed in a pre-selected shape prepared substantially according to the process claimed claim 128.
